(19) United States
(12) Patent Application Publication
(10) Pub. No.: US 2014/0032397 A1
(43) Pub. Date: Jan. 30, 2014

(54) COMPUTER-IMPLEMENTED REAL-ESTATE LEASE PROGRAM

(71) Applicant: HYPERION HOMES LLC, Uniondale, NY (US)

(72) Inventors: WILLIAM J. YOUNG, Winnetka, IL (US); BENJAMIN HELLWEG, CHICAGO, IL (US)

(73) Assignee: HYPERION HOMES LLC, Uniondale, NY (US)

(21) Appl. No.: 13/660,064

(22) Filed: Oct. 25, 2012

Related U.S. Application Data
(60) Provisional application No. 61/677,250, filed on Jul. 30, 2012.

(51) Int. Cl. G06Q 30/06; G06Q 20/22

(52) U.S. Cl. 705/39; 705/307

(57) ABSTRACT

A computer-implemented, real-estate program identifying real-estate properties of interest to prospective tenants and investors and providing composite price information including purchase and non-purchase-related expenses about lease-to-purchase options.

### BACKGROUND OF THE PRESENT INVENTION

The present invention generally relates to a computer-implemented real-estate program for identifying real-estate properties and generating relevant financial information related to long term rental with a right to purchase the subject property during or at the conclusion of the lease.

People who do not have the means to purchase property outright, cannot qualify for a mortgage, or do not wish to purchase at this time are relegated to renting their home. This restriction significantly reduces the selection of available housing, and also does not allow tenants to ensure the long term availability of the home they are renting, as the owner may choose to sell the property or find a different use for it.

Therefore there is a need for a program to allow potential tenants to select for rental from the list of properties that are for sale in the market, by having either a real estate investor, or another third party purchase the property and renting it to the potential tenant, with the potential tenant having, or potentially having, a right to purchase the property later at a price that is either pre-determined, or determined in accordance with pre-agreed formulae.

### SUMMARY OF THE INVENTION

According to the teachings of the present invention there is provided computer-implemented method for leasing real estate property, the method includes, A computer-implemented method for leasing real estate property, the method including, providing a network-enabled, computer system in communication with at least one real-estate provider; receiving property identifying parameters through the computer system; using the computer system to calculate a projected purchase price of a real estate property most closely matching the parameters, the real-estate property owned by at least one real-estate property owner; retrieving at least one non-purchase-related expense associated with the real-estate property; and using the computer system to present a composite rental rate calculated from the projected purchase price and at least one non-purchase-related expense associated with the real-estate property.

According to a further feature of the present invention, there is also provided leasing the real-estate property to the lessee in exchange for payment of a rental rate according to a lease agreement, the rental rate being at least partially based on the proposed rental rate.

According to a further feature of the present invention, the lease agreement is implemented in conjunction with a right to purchase the real estate property.

According to a further feature of the present invention, the right to purchase the real-estate property is integral to the lease agreement.

According to a further feature of the present invention, the right to purchase the real-estate property is implemented as a non-integral agreement to the lease agreement.

According to a further feature of the present invention, there is also provided selling the real-estate property to the tenant.

According to a further feature of the present invention, there is also provided buying the real-estate property from the real-estate property owner.

According to a further feature of the present invention, the projected purchase price is at least partially based on a list price for the real estate property.

According to a further feature of the present invention, the proposed rental rate is at least partially based on a predefined target return rate.

According to a further feature of the present invention, the predefined target return rate includes a fixed sum.

According to a further feature of the present invention, the non-purchase-related expense associated with the real-estate property includes a property tax.

According to a further feature of the present invention, the non-purchase-related expense associated with the real-estate property includes upgrade costs of the real-estate property.

There is also provided according to the teachings of the present invention, a computerized system for determining a composite a rental fee for leasing a real-estate property with a right to purchase, the system including: a computer system including: at least one network-enabled computer interfacing with a real-estate provider; the computer configured to receive real-estate-identifying parameters wherein the computer system is configured to:determine a projected purchase price of a real-estate property most closely matching the parameters, the real-estate property owned by at least one real-estate property owner, and retrieve at least one non-purchase-related expense associated with the real-estate property present a composite rental rate for leasing the real-estate property calculated from the projected purchase price and the non-purchase related expense.

According to a further feature of the present invention, the lease agreement is implemented in conjunction with a right of the lessee to purchase the real-estate property.

According to a further feature of the present invention, the projected purchase price is at least partially based on a list price for the real-estate property.

According to a further feature of the present invention, the composite rental rate is at least partially based on a predefined target return rate.

According to a further feature of the present invention, the non-purchase related expense includes a property tax.

According to a further feature of the present invention the non-purchase related expense includes upgrade costs to the real-estate property.

There is also provided according to the teachings of the present invention, a non-transitory computer-readable medium having stored thereon instructions to determine terms of a lease agreement in conjunction with the right to buy, which when executed by a processor cause a computer to perform the instructions includes: receiving property parameters associated with at least one desired real estate property; calculating a projected purchase price of at least one real estate property having parameters most closely matching the property parameters; retrieving at least one non-purchase related expense associated with the property; and calculating a composite rental rate for leasing the property in conjunction with a right to purchase.

According to a further feature of the present invention, the projected purchase price is at least partially based on a list price of the real estate property.

According to a further feature of the present invention, the composite rental rate is at least partially based on a predefined target return rate.

According to a further feature of the present invention, the non-purchase-related expense includes a property tax.

The non-transitory computer-readable medium of claim 19, non-purchase-related expense includes upgrade costs to the real-estate property.

### BRIEF DESCRIPTION OF THE DRAWINGS

The subject matter regarded as the invention is particularly pointed out and distinctly claimed in the concluding portion of the specification. The components, features, method of operation, and advantages of the invention may best be understood by reference to the following detailed description and accompanying drawings in which:

FIG. 1 is a schematic depiction of a computer architecture in a which real-estate leasing program is implemented, according to embodiments of the invention;

FIG. 2 is a flow diagram of steps performed by the real-estate leasing program and investor to provide a lessee with a right to purchase, according to embodiments of the invention; and

FIG. 3 is a schematic depiction of a sample page retrieved from a real estate provider; according to an embodiment of the present invention.

It will be appreciated that for the sake of clarity, elements shown in figures have not necessarily been drawn to scale and reference numerals may be repeated in different figures to indicate corresponding or analogous elements.

### DETAILED DESCRIPTION OF THE PRESENT INVENTION

The following detailed description includes numerous details in order to provide a thorough understanding of the invention. However, it will be understood by those skilled in the art that the present invention may be practiced without these specific details. For the sake of clarity, well-known methods, procedures, and components are not described in detail.

The present invention is a computer-implemented, real-estate lease program providing potential tenants with the possibility of remotely identifying rent and purchase opportunities of properties in a framework of leasing with purchasing rights.

A real estate investor, for example, buys real-estate property in which a potential tenant has expressed a desire to lease in conjunction with a right to purchase. The investor may then enter into a lease arrangement with the potential tenant providing him with a right to buy the property subsequently Implementation may be at least partially achieved by way of network-linked computers interfacing with a real estate provider, according to embodiments.

The advantages of such a scheme are multifold for both the purchasing and the leasing parties. Firstly, potential tenants who are unable or unwilling to purchase a property at this time are able to select, rent and control purchase right over a property they may wish to purchase later. Secondly, investors/real estate buyers are able to acquire properties for which an interested tenant and potential purchaser has already been identified. Thirdly, sellers will benefit from an expanded pool of potential buyers. Fourthly, properties that were previously only available to buyers are now available to renters, thereby providing a broader range of rental properties.

The following terms will be used though the document:

“Real estate” refers to non-moveable assets like permanent buildings, land and its natural resources. For convenience, the present document describes the invention in terms of an apartment without diminishing the scope of the invention.

“List price”, “listing”, or asking price all refer to the initial price the property at the onset of negotiations.

“Real-estate investor” or “investor” refers to a party buying property in which qualified potential tenants have expressed an interest in renting for the sake of leasing the property in conjunction with a right to purchase.

“Right to purchase integral to a lease agreement” refers to a right to purchase included as part of the terms of the lease for the property.

“Right to purchase non-integral to the lease agreement” refers to a right to purchase a property included in a contract that is linked-to, but separate from the contract to lease the property

“Real-estate provider” refers to at least one computer configured to act as Web server and to provide other real-estate-related services.

“Identifying parameters” refer to various property related features used to identify a particular real-estate property of interest by a computer.

“Composite rental rate” refers to an inclusive rental rate reflecting a variety of expenses including those that are directly related to the purchase of the property and those expenses not directly related to the purchase. Non-limiting examples of non-purchase-related expenses include, inter alia, property taxes and upgrade expenses. In certain embodiments, the composite rental rate may be an all-expense-inclusive figure.

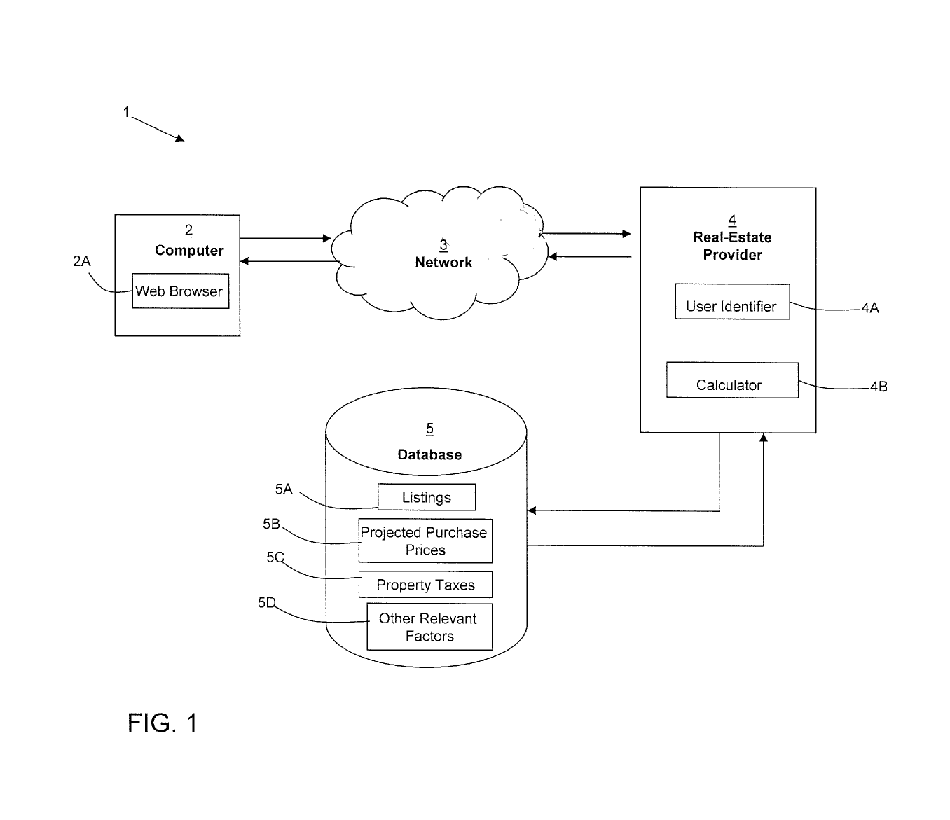

Turning now to the figures, FIG. 1 depicts a non-limiting embodiment of a computer network architecture 1 employed in the present invention. The system 1 includes computer 2 interfacing with real-estate provider 4 through a network 3. As shown, real-estate provider 4 is linked to an external database 5, according to a certain embodiment; but it should be appreciated that it may include an integral data base in other embodiments. Furthermore, it should be appreciated that the network connection may include any combination of wireless and wired connections employed in an intranet, the World Wide Web, or a combination of them as is known to those skilled in the art. As shown, computer 2 interfaces real-estate provider 4 by way of browser 2A, according to certain embodiments. Real-estate provider 4 includes a user identification module 4A and a calculator module 4B for estimating purchase price and calculating a monthly rental fee based on, the listings 5A, projected purchase prices 5B, property taxes 5C and other relevant financial factors or expenses 5D as is known in the art.

It should be appreciated that non-transitory, computer-readable medium having stored thereon instructions to determine terms of the lease agreement in conjunction with the right to buy, which when executed by a processor is also included in within the scope of the present invention. “Terms of the lease agreement” include the projected purchase price and the proposed monthly rental rate, for example.

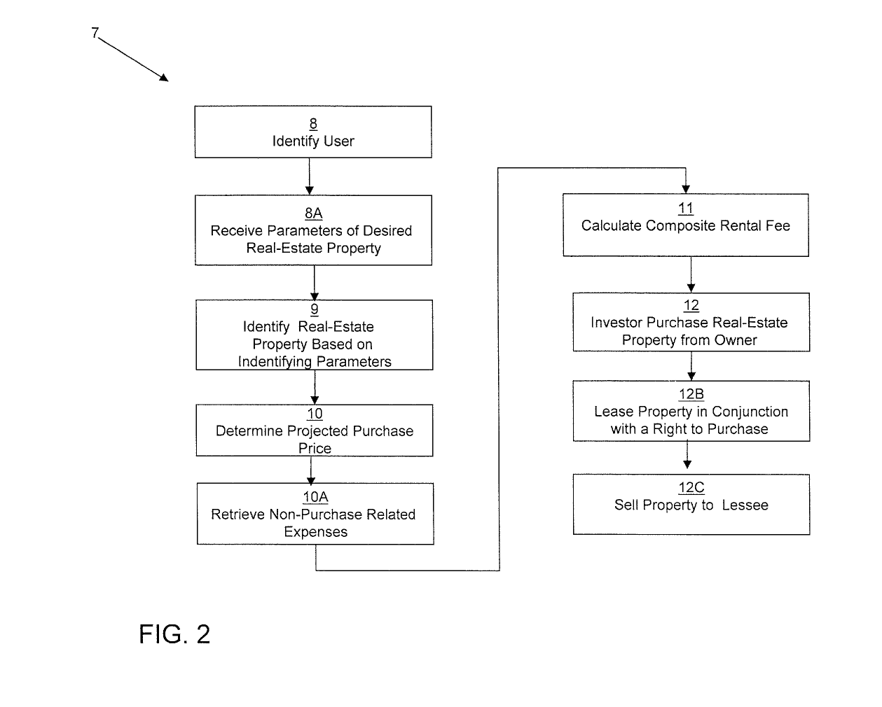

FIG. 2 depicts the steps of the above-described lease program according to an embodiment of the invention. Referring now to both FIGS. 1 and 2, in step 8, user identification module 4A identifies a user by comparing identifying information supplied by the user at computer 2 with information stored in database 5.

After verification of the user information, in step 8A identifying property parameters associated with at least one desired real-estate property are received from the user via computer terminal 2, according to an embodiment. Such parameters may include, inter alias, location, size, number or rooms, proximity to schools and shopping facilities, for example In step 9, real-estate provider 4 identifies from the listings 5A of database 5 properties having parameters most closely matching the parameters associated with the desired real-estate property and displays them at computer 2.

In step 10, real-estate provider 4 determines a prospective or projected purchase price. It should be appreciated that for the purposes of purchase price calculations, the terms “prospective”, “indicative”, and “projected” purchase price all refer to a purchase price that is based on the list or asking price as opposed to an actual purchase price arrived at through negotiation, according to embodiments. The projected purchase price may be derived from the list price in several different ways; for example:
1) The regular list or asking price.
2) A formula which includes a discount to the list asking price based on the type of listing.
3) A formula which includes a discount to the list price based on recent transactions in the neighborhood as defined by the ZIP code
4) A formula which includes a discount to the list price based both on the type of listing and recent transactions in the neighborhood as defined by the ZIP code.

Specifically, an example of a formula which includes a discount to the list asking price based on the type of listing is:

Indicative or Projected Purchase Price=F(type of sale)×List price.

Wherein F(type of sale) is a constant, depending on the type of sale, for example real estate owned by banks or other lenders (REO), a short sale, or other listing, or ‘For Sale’ by the owner, and has a value range defined as: 0<F(type of sale)<1.25;
wherein “List price” is the asking price shown on the listing.

An example of formula which includes a discount to the list price based on recent transactions in the neighborhood as defined by the ZIP code is:

Indicative Purchase Price=F(ZIP)×List price.

Wherein F(ZIP) is a constant, using a matrix set up by the investor for each ZIP code, or set using the average per cent difference between asking and transaction price in the relevant ZIP code over the last month, three months, six months, or year; and has a value range defined as: 0<F(ZIP)<1.25;
wherein “List price” is the asking price shown on the listing. It should be noted that the matrix may be set up by assigning a single value to each area as defined by its ZIP code.

A formula which includes a discount to the list price based both on the type of listing and recent transactions in the neighborhood as defined by the ZIP code is:

Indicative Purchase Price=F(ZIP, type of sale)×List price.

Wherein “F(ZIP, type of sale)” is a constant retrieved from a lookup table that includes a value for each ZIP code and type of sale, or it is set using the average per cent difference between asking and transaction price in the relevant ZIP code for the relevant type of transaction over the last month, three months, six months, or year, and has a value range defined as: 0<“F(ZIP, type of sale)”<1.25;
wherein “Type of sale” is either REO, Short Sale, Other Listing, Tor Sale' by owner;
wherein “ZIP” is the ZIP code where the property is located; and
wherein “List price” is the asking price shown on the listing as noted above.

It should be appreciated; that additional methods of calculating prospective purchase price in accordance with additional parameters are also included within the scope of this invention.

In step 10A, non-purchase related expenses corresponding to the property and interest and chosen upgrades, for example. These expenses may be retrieved from any data base in communication with real-estate provider 4 including data bases of external contractors or other relevant agents capable of providing desired home or garden improvements, for example.

In step 11 composite rental rate is calculated, on the basis of the above-described purchase price and additional expenses related to the property of interest. It should be appreciated that the composite rental rate is a proposed rental rate, in certain embodiments, and may be different than an “actual rental rate” or “rental rate” negotiated by the lessor and the lessee beginning from the proposed rental rate, according to a certain embodiment. According to certain embodiments, the composite rental rate is presented by displaying on a computer screen in communication with the provider, printed, faxed, or sent as a text message or other form of user interface.

The proposed rental rate may be calculated by way of the following relationships, for example:

Proposed monthly rental rate or price=[(Projected Purchase Price×Target Return Rate)+Property Tax]/12 (months per year).

Wherein “Target Return Rate” may be calculated in two ways, according to embodiments.
1) It may be calculated as a fixed number to account for operating costs according to the following formula:

Target Return Rate=(Annual Management Costs/Purchase Price)+Target Net Annual Return;
2) Alternatively, the target return rate by calculated as a fixed percentage increase of the total cash basis in the property.

Additional factors that may be used to determine a target return rate include, inter alia, current risk free interest rates, current rates for interest rate swaps, and current short term rates as measured either by the Fed Funds rate, and the LIBOR rates or Prime banking rate.

Returning to calculation of the proposed monthly rental price, additional factors that may determine monthly rental price include, inter alias, normalized repair costs, normalized vacancy, substantial repairs, tenant-requested upgrades, prospective purchase price of the property, fixed percent increases based on current rental price, published inflation index such as CPI-u (or other inflation indices,)

It should be appreciated that in certain embodiments the costs of requested upgrades may be determined either by directly calculating capital costs of the repair, or by using estimated future costs of the anticipated repair.

Furthermore, costs emanating from additional repairs or upgrades can be estimated as a function of the room type being upgraded or may be based on work quotes obtained from contractors.

In step 12 real estate investor purchase the property of interest from the property owner at a price different than the projected purchase price, according to embodiments.

In step 12B real estate investor enters into a lease arrangement with the lessee or potential tenant according to a lease agreement in which the lessor has a right to purchase the real-estate property from the lessor at a proposed monthly rental rate or at an actual rate negotiated with the lessor, according to embodiments. The right to purchase may be implemented as a right integral to the lease agreement or as a right non-integral right to the lease agreement

In step 12C lessor sells the real-estate property at a projected purchase price that may be based on the investor's total cash basis in the property, a fixed profit amount or a fixed percentage increase of the total cash basis in the property, price that is adjusted annually based on a fixed percentage increase or changes in an inflation index such as the CPI-u (or other published inflation indices), total cash basis.

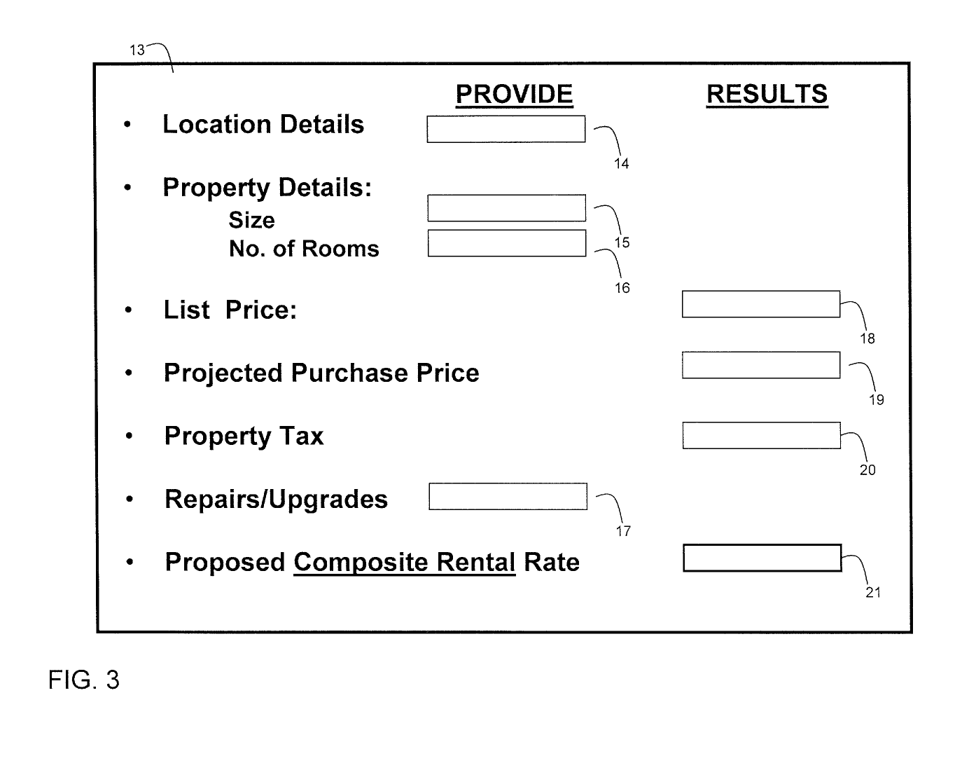

FIG. 3 depicts a sample web page, generally designated 13, retrieved from real-estate provider 4 and displayed at computer 2. The page 13 includes fields for property parameters to be supplied by a user or potential tenant and information to be supplied responsively by real-estate provider 4 based on data stored in data bank 5 and associated algorithms.

In operation, the user supplies desired property parameters like, location, size, and number of rooms in fields 14-16, respectively. Accordingly, real-estate provider 4 retrieves a list price for a property having parameters most closely matching those supplied by the user and displays the list price in field 18. A projected purchase price, as calculated above, is displayed in field 19, and associated property tax is displayed in field 20. Desired repairs or upgrade expenses are provided by the user in field 17 and a monthly rental price is calculated according to the above described sample formula and displayed in field 21.

It should be appreciated that additional or alternative fields may be supplied by the user or by the real estate provider; all depending on the needs of the relevant parties.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A computer-implemented method for leasing real estate property, the method comprising,
providing a network-enabled, computer system in communication with at least one real-estate provider;
receiving property identifying parameters through the computer system;
using the computer system to calculate a projected purchase price of a real estate property most closely matching the parameters, the real-estate property owned by at least one real-estate property owner;
using the computer system to calculate a proposed rental rate for leasing the real-estate property to a lessee at least partially based on the projected purchase price;
retrieving at least one non-purchase-related expense associated with the real-estate property; and
using the computer system to present a composite rental rate calculated from the projected purchase price and at least one non-purchase-related expense associated with the real-estate property.

2. The method of claim 1, further comprising leasing the real-estate property to the lessee in exchange for payment of a rental rate according to a lease agreement, the rental rate being at least partially based on the proposed rental rate.

3. The method of claim 2, wherein the lease agreement is implemented in conjunction with a right to purchase the real-estate property.

4. The method of claim 3, wherein the right to purchase the real-estate property is integral to the lease agreement.

5. The method of claim 3, wherein the right to purchase the real-estate property is implemented as a non-integral agreement to the lease agreement.

6. The method of claim 3, further comprising selling the real-estate property to the tenant.

7. The method of claim 1, further comprising buying the real-estate property from the real-estate property owner.

8. The method of claim 1, wherein the projected purchase price is at least partially based on a list price for the real estate property.

9. The method of claim 1, wherein the proposed rental rate is at least partially based on a predefined target return rate.

10. The method of claim 9, wherein the predefined target return rate includes a fixed sum.

11. The method of claim 1, wherein the non-purchase-related expense associated with the real-estate property includes a property tax.

12. The method of claim 1, wherein the non-purchase-related expense associated with the real-estate property includes upgrade costs of the real-estate property.

13. A computerized system for determining a composite a rental fee for leasing a real-estate property with a right to purchase, the system comprising:
a computer system including:
at least one network-enabled computer interfacing with a real-estate provider; the computer configured to receive real-estate-identifying parameters
wherein the computer system is configured to:
determine a projected purchase price of a real-estate property most closely matching the parameters, the real-estate property owned by at least one real-estate property owner,
retrieve at least one non-purchase-related expense associated with the real-estate property, and
present a composite rental rate for leasing the real-estate property calculated from the projected purchase price and the non-purchase related expense.

14. The system of claim 13, wherein the lease agreement is implemented in conjunction with a right of the lessee to purchase the real-estate property.

15. The system of claim 13, wherein the projected purchase price is at least partially based on a list price for the real-estate property.

16. The system of claim 13, wherein the composite rental rate is at least partially based on a predefined target return rate.

17. The system of claim 13, wherein the non-purchase related expense includes a property tax.

18. The system of claim 13, wherein the non-purchase related expense includes upgrades costs to the real-estate property.

19. A non-transitory computer-readable medium having stored thereon instructions to determine terms of a lease agreement in conjunction with the right to buy, which when executed by a processor cause a computer to perform the instructions comprising:
receiving property parameters associated with at least one desired real estate property;
calculating a projected purchase price of at least one real-estate property having parameters most closely matching the property parameters;
retrieving at least one non-purchase related expense associated with the property; and
calculating a composite rental rate for leasing the property in conjunction with a right to purchase.

20. The non-transitory computer-readable medium of claim 19, wherein the projected purchase price is at least partially based on a list price of the real-estate property.

21. The non-transitory computer-readable medium of claim 19, wherein the composite rental rate is at least partially based on a predefined target return rate.

22. The non-transitory computer-readable medium of claim 19, wherein the non-purchase-related expense includes a property tax.

23. The non-transitory computer-readable medium of claim 19, wherein the non-purchase-related expense includes upgrade costs to the real-estate property.
